(19) United States
(12) Patent Application Publication
(10) Pub. No.: US 2008/0059788 A1
(43) Pub. Date: Mar. 6, 2008

(54) Secure electronic communications pathway

(76) Inventors: Joseph John Tardo, Palo Alto, CA (US); Gandhar Prakash Gokhale, Pune (IN); Sandesh Sawant, Pune (IN); Sagar Shashikumar Bhanagay, Pune (IN); Vivek Gupta, Pune (IN)

Correspondence Address: PATRICK REILLY, P.O. BOX 7218, SANTA CRUZ, CA, 95061-7218, US

(21) Appl. No.: 11/513,332

(22) Filed: Aug. 30, 2006

(51) Int. Cl. H04L 9/00

(52) U.S. Cl. 713/153

(57) ABSTRACT

A system and method to enable a transparent, outboard, proxy secure channel between two endpoints on a Local Area Network (LAN) using front-end network encryption devices are provided. A secure channel provides an encrypted, authenticated communications pathway that protects an otherwise insecure communications network against threats including passive eavesdropping, active modification and insertion, and impersonation. One version provides a fully transparent secure channel between two endpoints which may be unaware of the data protection being applied. An alternate version enables single-ended communications protection between an endpoint transparently protected by a front-end network encryption device and a remote endpoint having compatible, interoperable encryption software. In a single-ended application, the remote endpoint may be unaware that (1.) the other endpoint is not performing the encryption nor that (2.) a front-end network encryption device is performing the encryption on its behalf.

### FIELD OF THE INVENTION

The Present Invention relates generally to electronic communications systems and techniques. More particularly, the Present Invention relates to systems and techniques used to transmit information within electronic messages that include information related to a source and a destination of the electronic message.

### BACKGROUND OF THE INVENTION

Large elements of the public and private spheres of the world economy presently rely upon electronic communications to effectively operate. The rapid proliferation of communications networks that incorporate digital computing technology has greatly increased the efficiency by which large amounts of information are collected and accessed while creating new dangers in the need to maintain information security and operational integrity of these networks. As a result or regulations or security policies, many enterprises are required to operate internal private networks that often need to exchange sensitive information with adequate internal safeguards.

In general, digital electronic communications are formatted as messages by means of a computational device, such as a personal computer, wherein the message specifies a message origination address and a destination address. The message origination address, or source address, may be the address of a device that originated or forwarded either the message or some content of the message. The prior art often applies encryption and authentication techniques to guard against the unauthorized insertion of electronic messages into information technologies systems and networks, and the unauthorized access to, or disclosure of information contained in electronic messages. Yet the prior art places the burden of communications security largely on the originating source computer and the computer designated as the destination of an electronic message. This depends upon either additional host software at both source and destination, or external “gateway” devices capable of locating the corresponding gateway at the intended destination. In a large communications network, the prior art may thereby impose costly and difficult to administrate requirements to update the security software of multiplicities of computers in order to maintain efficient message traffic.

The Internet is currently the single most ubiquitous and economically significant communications network. Under Internet Protocol (hereafter “IP”), a message may consist of one or more network packets where each network packet is separately transmitted, but each network package of a same message refers to a same (a.) message identification, (b.) IP source address, and (c.) IP destination address.

Technically, what distinguishes the Internet is its use of a set of protocols called TCP/IP (Transmission Control Protocol/Internet Protocol). Two recent adaptations of Internet technology, the intranet and the extranet, also make use of the TCP/IP protocol.

Electronic communications security refers to efforts and systems intended to create secure computing platforms and communications networks that are designed so that agents, e.g., human users and software programs, can only perform actions that have been allowed. Most attempted interactions with a computer network can be reduced to operations of access to, modification of, and/or deletion of information stored by, or accessible, a computer. Controlling authorization to direct the execution of commands by a computer or an electronics communications network typically involves specifying and implementing a security policy. The communications security community is challenged to develop electronic messaging policies, protocols, methods and systems that may be used to protect both information and devices accessible via an electronic communications network, e.g., the Net, from unauthorized access, corruption, degradation or destruction.

The Internet Protocol Security standard (hereafter “IPsec”) has been published and periodically updated in an effort to achieve these goals. IPsec may be described as a framework of open standards for ensuring secure private communications over the Internet. Based on standards developed by the Internet Engineering Task Force, IPSec attempts to increase the confidentiality, integrity, and authenticity of data communications across a public network. IPSec is intended to provide necessary components of a standards-based, flexible solution for deploying a network wide security policy.

The prior art also employs Internet Key Exchange (hereafter “IKE”). IKE is a cryptographic key negotiation protocol that allows IPsec users to agree on security services, i.e., authentication and encryption methods, the keys to use, and how long the keys are valid before new keys are automatically exchanged. Technically, IKE is a dual phase protocol, wherein phase 1 authenticates each peer and creates a secure encrypted link for doing phase 2—the actual negotiation of security services for the IPsec-compliant virtual private network channel. After phase 2 is completed, the protected link in phase 1 is torn down and data traffic abides by security services set forth in the phase 2 negotiations, e.g., encapsulating a security payload with triple data encryption.

The methods used in IKE attempt to protect against denial of service and man-in-the-middle attacks and ensures non-repudiation, perfect forward secrecy, and key security via periodic refreshing of keys.

### OBJECTS OF THE INVENTION

It is an object of the Method of the Present Invention to support the integrity of communications over an electronic communications network.

It is an additional object of the Method of the Present Invention to provide a method to process an electronic message by a network computer after transmission by the electronic message by a computer.

It is an additional object of the Method of the Present Invention to enable secure electronic communications.

### SUMMARY OF THE INVENTION

These and other objects will be apparent in light of the prior art and this disclosure. According to a first preferred embodiment of the Method of the Present Invention, or first method, a computer network includes a first endpoint communicatively coupled with a first network computer, and a second endpoint communicatively coupled with a second network computer The term endpoint as used herein identifies a computer that is configured to both communicate with an electronic communications network and to establish communications with one or more other endpoints.

The first method may provide a transparent, outboard, communications channel between two endpoints that is enabled by two network computers, wherein the network computers act in concert to encrypt, decrypt and authenticate one or more electronic messages originated by one of the endpoints.

The first method enables encrypted and authenticated electronic communications over a computer network, such as a local area network (hereafter “LAN”). A LAN is defined herein to identify a computer network that spans a relatively small area. Most LANs are confined to a single building or group of buildings. However, one LAN can be connected to other LANs over any distance via telephone lines and radio waves. A system of LANs may be connected in this way. There are many different types of LAN technologies, Ethernets being the most common in use.

In accordance with the first method, the first endpoint uses an interface to a first secure network access device to send a message, e.g., a network packet, addressed to the second endpoint. The first secure network access device transparently encrypts and authenticates the network packet on behalf of the first endpoint, such that the network packet retains the source and destination addresses as sent by the first endpoint. The first secure network access device then forwards the network packet into the LAN. The LAN then switches or routes the network packet to the second secure network access device over the same path as the network packet would have used had the encryption not been applied, and delivering the packet addressed to the second endpoint through the second secure network access device. The second secure network access device transparently decrypts and authenticates the network packet on behalf of the second endpoint and then provides the network packet to the second endpoint. In certain variations of the first method, the network packet is authenticated but not encrypted.

In certain still alternate variations of the first method, (a.) the second endpoint sends a network packet to the first endpoint via an interface to the second secure network access device, and (b.) the first endpoint uses an interface to the first secure network access device to receive the network packet originated by the second endpoint and addressed to the first endpoint. The first secure network access device receives the encrypted network packet from the LAN, transparently decrypts and authenticates the network packet on behalf of the first endpoint, and then forwards the decrypted network packet to the first endpoint. The LAN may optionally, additionally or alternatively switch or route the network packet over the same path as the network packet would have used had the encryption not been applied, whereby the first secure network access device and the second secure network access device in combination transparently encrypt, decrypt and authenticate the network packet addressed to the first endpoint and originated by the second endpoint.

The encrypted network packet may appear in transit within the LAN, or other computer network, to have been encrypted by the first endpoint. Additionally, optionally or alternatively the first endpoint and/or the second endpoint may further comprise an encryption acceleration hardware used to encrypt and/or decrypt the network packet.

According to certain alternate preferred embodiments of the Method of the Present Invention, the computer network may further comprise, in addition to the first endpoint, the second endpoint, the first secure network access device and the second secure network access device, a first plurality of endpoints. The first plurality of endpoints may be communicatively coupled with the first secure network access device, and the first secure network access device may be configured to encrypt and authenticate messages sent from the first plurality of endpoints and to decrypt and authenticate messages sent to any endpoint of the first plurality of endpoints. The first plurality of endpoints may be physically connected to the first secure network access device and the first secure network access device may provide the network access for the first plurality of endpoints. The computer network may additionally, optionally or alternatively provide intermediate forwarding devices, wherein the intermediate forwarding devices are transposed between at least one endpoint of the first plurality of endpoints and the first secure network access device.

According to certain still alternate preferred embodiments of the Method of the Present Invention, the encrypting and decrypting of network packets may comply with the IPsec encryption standard RFC2401, and the encrypted messages may comprise Media Access Control (hereafter “MAC”) address and/or IP address of at least one communicating endpoints. Furthermore, the generation and the transmission of encrypted messages may be accomplished in conformance with either IPsec transport mode or IPsec tunnel mode.

In certain yet alternate preferred embodiments of the Method of the Present Invention, the encryption method may include IKE key management, wherein the secure network access device and/or endpoint may provide a front-end proxy IKE key negotiation capability using the MAC and IP addresses of the first and second endpoint. The encryption method may additionally, optionally or alternatively authenticate endpoints as members of a trusted domain, wherein the first secure network access device can authenticate itself as a member of a trusted domain, and the first secure network access device may authenticate remote endpoints and alternate secure network access devices as members of the trusted domain.

In other alternate preferred embodiments of the Method of the Present Invention, at least one encryption policy for selectively encrypting communications packets may be centrally administered, such that both the first secure network access device and the second secure network access device can be substantively contemporaneously configured. Policy configuration may additionally, optionally or alternatively apply or generate rules substantively similar to stateful firewall rules, but independent of any firewall functionality of one or more secure network access devices in the computer network.

In still other alternate preferred embodiments of the Method of the Present Invention, a central management configuration may have an option to simply designate one or more servers for protection using encrypted traffic, wherein at least one encryption policy of both the first secure network access device and the second secure network access device may be automatically generated and configured. Additionally, optionally or alternatively, a central management configuration may (a.) associate users with one or more user groups, wherein at least two user groups have separate associated policy rules, and the relevant policy rules are merged when needed to generate an encryption policy, and/or (b.) creates new groups for merging with existing policy rules in order to implement automatic generation of central configuration policies.

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. 1 is a schematic of a communications network including a plurality of secure network access devices and endpoints;

FIG. 2 is a schematic of an endpoint of FIG. 1;

FIG. 3 is a schematic of a secure network access device of FIG. 1;

FIG. 4 is a format diagram of a network packet that may be transmitted between the endpoints of FIGS. 1 and 2 and by means of the communications network of FIG. 1;

FIG. 5 is a flowchart of a processing of a message in accordance with a first preferred embodiment of the Method of the Present Invention, or first version, as implemented by the communications network, the endpoint and the secure network access device of FIGS. 1, 2 and 3;

FIG. 6 is a flowchart of an alternate, optional or additional processing of a message in accordance with a first preferred embodiment of the Method of the Present Invention, or first version, as implemented by the communications network, the endpoint and the secure network access device of FIGS. 1, 2 and 3; and

FIG. 7 is a flowchart of an alternate preferred variation of the first method of FIGS. 5 and 6.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

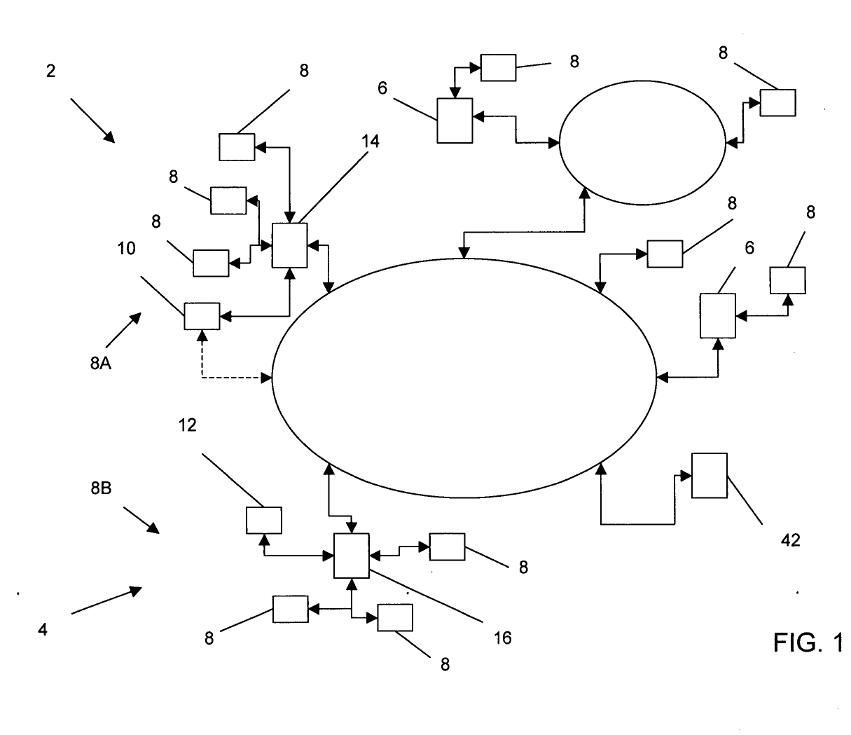

Referring now generally to the Figures and particularly to FIG. 1, FIG. 1 is a schematic of an electronics communications network 2 that includes the Internet 4, a plurality of network computers 6 and a plurality of endpoints 8. Each endpoint 8, to include a first endpoint 10 and a second endpoint 12, is configured to send and to receive electronic messages via at least one secure network access device 6, 14 & 16. Each network access device 6, to include a first secure network access device 14 and a second secure network access device 16, is configured to send and receive electronic messages via the communications network 2. Each secure network access device 6, 14 & 16 may optionally be configured to receive electronic messages from at least one endpoint 8, 10 & 12 and to forward on the electronic messages received from the at least one endpoint 8, 10 & 12 to the Internet 4. Each secure network access device 6, 14 & 16 may additionally, optionally or alternatively be configured to receive electronic messages from the Internet 4 and/or the communications network 2 and to forward on the electronic messages received from the Internet 4 and/or communications network 2 to at least one endpoint 8, 10 & 12.

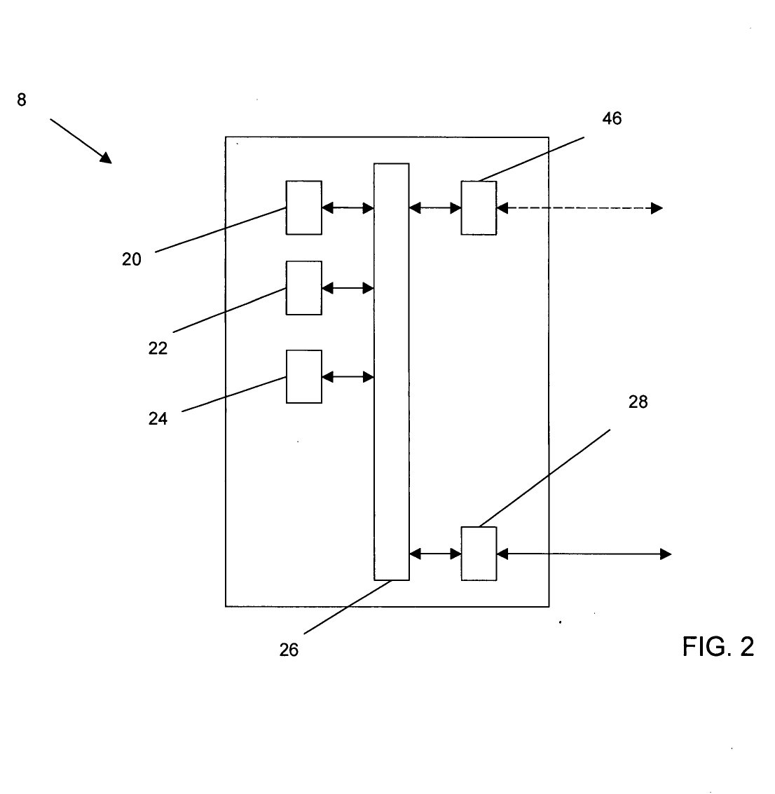

Referring now generally to the Figures and particularly to FIG. 2, FIG. 2 is a schematic of an endpoint 8, 10 & 12. The endpoint 8, 10 & 12 is a digital computer that includes a processor 18, a memory 20, an input device F, a monitor 24, an internal endpoint communications bus 26 and a message interface 28. An endpoint 8, 10 or 12 may be comprised within a server or an intelligent peripheral device, such as a printer having a processor 18, a memory 20, and a message interface 28. The internal endpoint communications bus 26 bi-communicatively couples, and provides bi-directional communication to, the processor 18, the memory 20, the input device 22, the monitor 24, and the message interface 28. The input device 22 may be or comprise an electronic keyboard or other suitable input device known in the art that enables a human user to provide content to the endpoint 8, 10 or 12 for an electronic message. The memory 20 stores endpoint software that directs the processor 18 to generate, transmit and receive electronic messages. The monitor 24 may be or include a video monitor or other suitable output device that enables the human user to view at least some of the content of an electronic message. The message interface 28 bi-directionally communicatively couples the internal communications bus 26 with at least one secure network access device 6, 14 or 16, whereby the endpoint 8, 10 & 12 may send and/or receive electronic messages to and/or from the Internet 4 and/or the communications network 2.

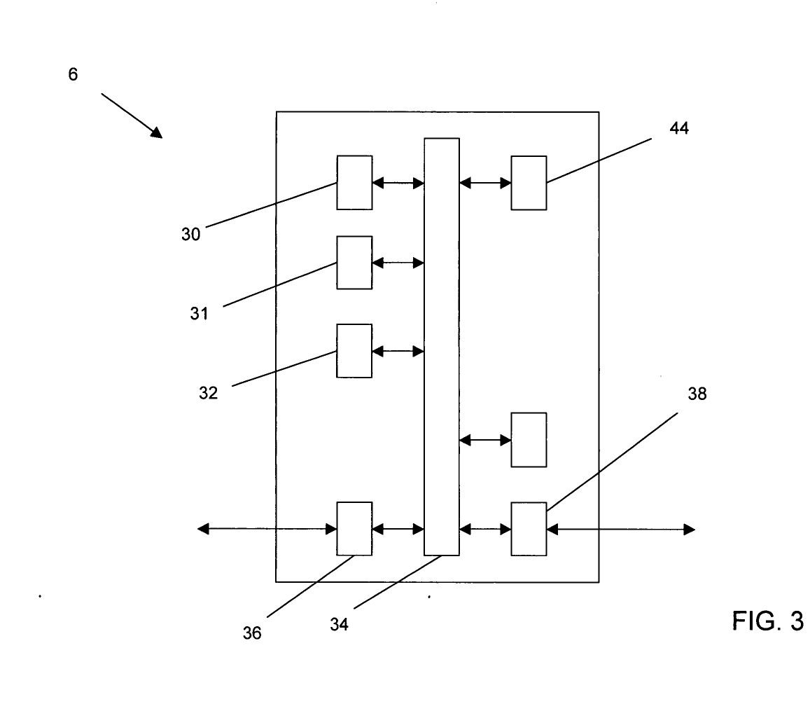

Referring now generally to the Figures and particularly to FIG. 3, FIG. 3 is a schematic of a secure network access device 6, 14 & 16. The secure network access device 6, 14 & 16 includes a data plane network processor 30, a control plane processor 31, a network memory 32, a network internal communications bus 34, an endpoint interface 36, and a network interface 38. The network internal communications bus 34 bi-communicatively couples, and provides bi-directional communication to, the data plane network processor 30, the network memory 32, the endpoint interface 36, and the network interface 38. The network memory 32 stores the network access device system software that directs the data plane network processor 30 to generate, transmit and receive electronic messages to and/or from the Internet 4, the communications 2, and/or at least one endpoint 8, 10 or 12. The network interface 38 bi-directionally communicatively couples the network internal communications bus 34 with the Internet 4 and/or the communications network 2. The endpoint interface 36 bi-directionally communicatively couples the network computer 6, 14 or 16 with at least one endpoint 8, 10 or 12, whereby the endpoint 8, 10 & 12 may send and/or receive electronic messages to and/or from the Internet 4 and/or the communications network 2, by means of the secure network access device 6, 14 & 16.

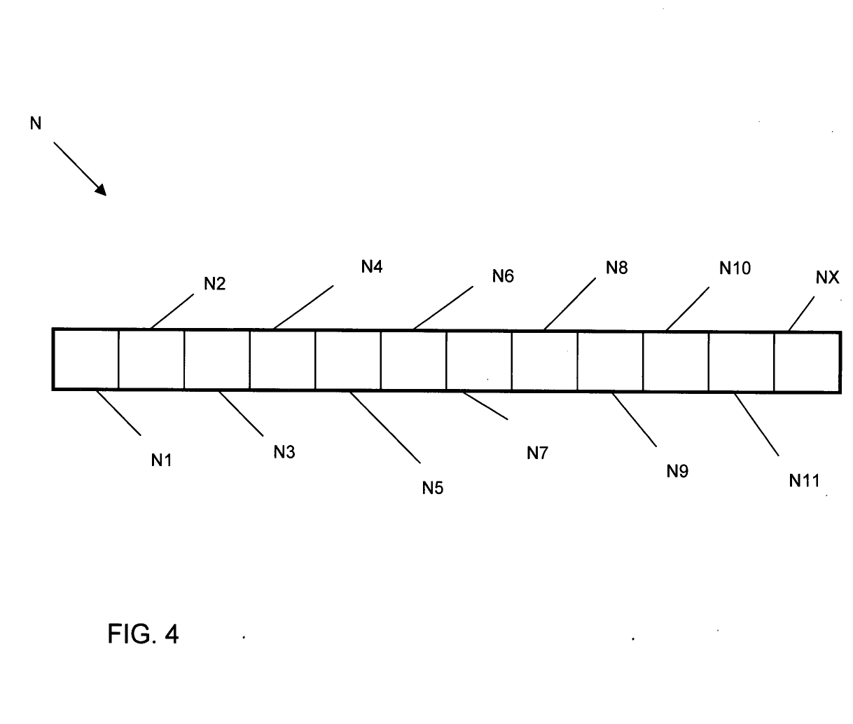

Referring now generally to the Figures and particularly to FIG. 4, FIG. 4 is a format diagram of a network packet N, the network packet N including packet data fields N1-NX, and the network packet formatted in accordance with the IPsec standard or another suitable electronic communications and data security message formatting known in the art. The header data field N contains information related to the network packet N, to include the source address S.ADDR and the destination address D.ADDR. A message payload is stored in a payload data field N2, and other information is stored in the remaining packet data fields N3-NX. The network packet N may be transmitted between the endpoints 8, 10, 12 and by means of the communications network 2.

It is understood that encrypting and decrypting of network packets in accordance with the first method may comply with the IPsec encryption standard (RFC2401), and the encrypted messages may comprise the MAC and IP addresses of the communicating endpoints.

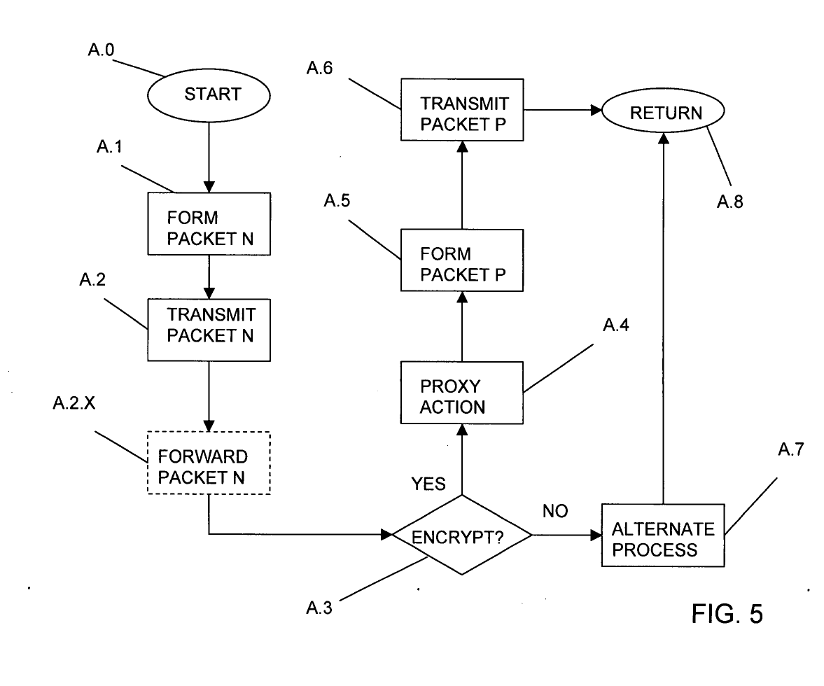

Referring now generally to the Figures and particularly to FIG. 5, GIG. 5 is a flowchart of a processing of a message in accordance with a first preferred embodiment of the Method of the Present Invention, or first version, as implemented by the communications network 2, the endpoints 8, 10, 12 and the secure network access devices 6, 14, 16 of FIGS. 1, 2 and 3. In step A.1 the first endpoint 10 formats and generates a network packet N, wherein the source address value S.ADDR identifies the first endpoint 10 as the message source and the destination address D.ADDR identifies the second endpoint 12 as the intended message recipient. In step A.2 network packet N is transmitted by the first endpoint 10 to the first secure network access device 14. In step A.3 the first secure network access device 14 examines the network packet N to determine whether the network packet N shall be encrypted. In executing step A.3, the first secure network access device 14 may apply stateful rules to determine whether the network packet N shall be encrypted. When the first secure network access device 14 determines in step A.3 that the network packet N shall be encrypted prior to transmission via the network 2, the first secure network access device 14 engages with the communications network 2 in step A.4 as a proxy for the first endpoint 10 and performs IKE and authentication operations in concert with either the second endpoint 12 or the second secure network access device 16 via the communication network 2. In step A.5 the first secure network access device 14 processes the network packet N with encryption and/or authentication algorithms to generate a processed network packet P. The processed network packet P may be organized and formatted to appear just as the network packet N would have appeared had the first endpoint 10 performed the steps A.4 and A.5. The first secure network access device 14 then transmits the processed network packet P via the communications network 2 along the same pathway that the network packet N would have traveled had the network packet N not been processed by the first secure network access device 14. It is understood that encrypting of step A.5 of network packets N in accordance with the first method may comply with the IPsec encryption standard (RFC2401), and the encrypted network packet P may comprise the MAC and IP addresses of the communicating endpoints 8, 10 OR 12.

In optional step A.2.X an intermediate network device 40 that is transposed between the first endpoint 10 and the first secure network access device 14 receives the network packet N from the first endpoint 10 and forwards on the network packet N to the first secure network access device 14 without changes the format or content of the network packet N. As per FIGS. 1 and 3, the intermediate network device 40 is a network access device 6 configured according to the network access device schematic of FIG. 3, and wherein the network interface 38 of the intermediate computer 40 bi-directionally communicatively couples the network internal communications bus 34 of the intermediate network access device 40 with the first secure network access device 14.

It is understood that a first plurality 8A of endpoint computers 8 may be communicatively coupled with first secure network access device 14, wherein the first secure network access device 14 may act as a proxy for each of the coupled endpoint computers 8 and process network packets N received from each coupled endpoint computer 8 of the first plurality 8A in accordance with the network system software of the first secure network access device 14. It is further understood that a second plurality 8B of endpoint computers 8 may be communicatively coupled with second secure network access device 16, wherein the second secure network access device 16 may act as a proxy for each of the coupled endpoint computers 8 of the second plurality 8A and process network packets N received from each coupled endpoint computer 8 in accordance with the network system software of the second secure network access device 16.

In certain preferred alternate embodiments of the Method of the Present Invention, the first secure network access device 14 may elect to process network packets N received from the first endpoint 10 and/or an endpoint 8 of the first plurality of endpoints 8 in concert with or in accordance with instructions received from a controller network computer 42 of the communications network 2. The controller network computer 42 is a network computer 6 configured according to the network computer schematic of FIG. 3, and wherein the network interface 38 of the controller network computer 42 bi-directionally communicatively couples the network internal communications bus 34 of the controller network computer 42 with the first secure network access device 14 via the communications network 2.

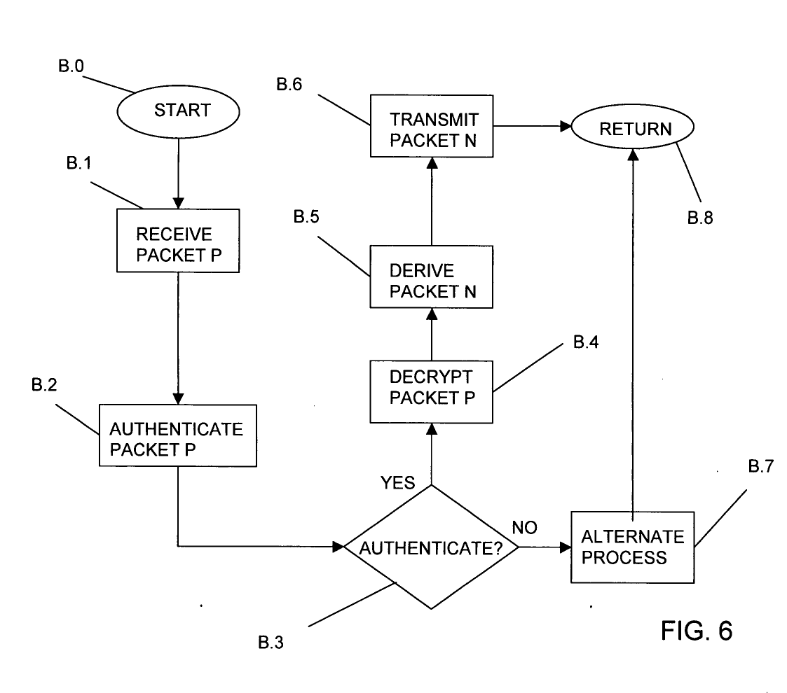

Referring now generally to the Figures and particularly to FIG. 6, FIG. 6 is a flowchart of an alternate, optional or additional processing of a message in accordance with a first preferred embodiment of the Method of the Present Invention, or first version, as implemented by the communications network, the endpoint and the secure network access device of FIGS. 1, 2 and 3. In step B.1 the second endpoint computer 16 receives the processed network packet P via the communications network 2. In step B.2 the second secure network access device 16 authenticates the processed network packet P. After confirming authentication is step B.3, the second secure network access device 16 decrypts the processed network packet P and derives the network packet N from the processed network packet P in step B.4. It is understood that the decrypting of step B.4 of network packets N in accordance with the first method may comply with the IPsec encryption standard (RFC2401), and the encrypted network packet P may comprise the MAC and IP addresses of the communicating endpoints 8, 10 OR 12. The second secure network access device 16 derives the network packet N in step B.5 from the results of the authentication step B.2 and the decryption step B.4. In step B.6 the network packet N is transmitted from the second secure network access device 16 to the second endpoint 8, whereby the second endpoint 8 receives the network packet N and the processing performed by the first secure network access device 14 and the second secure network access device 16 on the network packet N and the processed network packet P is transparent to and undetected by the second endpoint computer.

Referring now generally to the Figures, and particularly to FIGS. 3, 5 and 6, it is understood that the encryption of the network packet N performed in step A.5 of FIG. 5 may be at least partially accomplished by encryption acceleration hardware 44 of the first secure network access device 12. It is further understood that the decryption of the processed network packet P performed in step B.4 of FIG. 6 may be at least partially accomplished by encryption acceleration hardware 44 of the second secure network access device 16.

In certain other alternate preferred embodiments of the Method of the Present Invention, the first endpoint 10 and/or the second endpoint 12 may send and receive network packets N with the intermediation of only one secure network access device 6, 14 or 16. In certain alternate preferred exemplary alternate configurations of the first endpoint 10, the first endpoint 10 may further comprise an endpoint-network interface 46, as per FIG. 2, wherein the endpoint-network interface 46 communicatively couples the endpoint internal communications bus 26 of the first endpoint 10 directly with the communications network 2 and/or the Internet 4. Additionally, optionally or alternatively, certain still alternate preferred exemplary alternate configurations of the second endpoint 12, the second endpoint 12 may further comprise an endpoint-network interface 46, as per FIG. 2, wherein the endpoint-network interface 46 communicatively couples the endpoint internal communications bus 26 of the second endpoint 12 directly with the communications network 2 and/or the Internet 4.

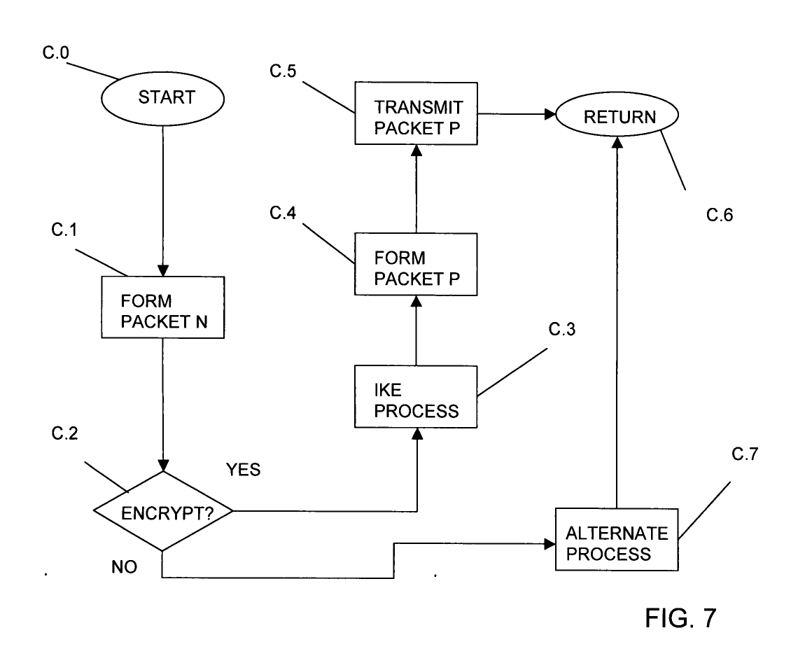

Referring now generally to the Figures and particularly to FIG. 7, FIG. 7 is a flowchart of an alternate preferred variation of the first method, wherein the first endpoint 10 uses the end-point network interface 46 to communicate with the second secure network access device 16 and to optionally authenticate and encrypt the network packet N prior to transmission from the first endpoint 10. In step C.1 the first endpoint 10 formats and generates a network packet N, wherein the source address value S.ADDR identifies the first endpoint 10 as the message source and the destination address D.ADDR identifies the second endpoint 12 as the intended message recipient. In step C.2 the first endpoint 10 examines the network packet N to determine whether the network packet N shall be encrypted. In executing step C.2, the first endpoint 10 may apply stateful rules of the endpoint software of the first endpoint 10 to determine whether the network packet N shall be encrypted. When the first endpoint 10 determines in step C.2 that the network packet N shall be encrypted prior to transmission via the network 2, the first endpoint 10 engages in step C.3 with the second secure network access device 16 via the communication network 2 to perform authentication and IKE data generation. In step C.4 the first endpoint 10 processes the network packet N with encryption and/or authentication techniques, and in accordance with the algorithms and data generated in step C.3, to generate a processed network packet P. The first endpoint 10 then transmits the processed network packet P via the communications network 2 in step C.5. After receipt of the processed network packet P, the second secure network access device 16 then authenticates and decrypts the processed network packet P in accordance with the flowchart of FIG. 6, wherein the second secure network access device 116 derives the network packet N from the processed network packet P, and provides the regenerated network packet N to the second endpoint 12.

It is understood that the second endpoint 12 additionally, optionally, alternatively may further comprise an endpoint network interface 46. Referring now generally to the Figures while continuing to refer particularly to FIG. 7, FIG. 7 the endpoint software of the second endpoint 12 may direct the second endpoint 12 to flowchart to execute an alternate preferred variation of the first method, wherein the second endpoint 12 uses the end-point network interface 46 to communicate with the first secure network access device 14 and to optionally authenticate and encrypt the network packet N prior to transmission from the second endpoint 12. In step C.1 the second endpoint 12 formats and generates a network packet N, wherein the source address value S.ADDR identifies the second endpoint 12 as the message source and the destination address D.ADDR identifies the first endpoint 10 as the intended message recipient. In step C.2 the second endpoint 12 examines the network packet N to determine whether the network packet N shall be encrypted. In executing step C.2, the second endpoint 12 may apply stateful rules of the endpoint software of the second endpoint 12 to determine whether the network packet N shall be encrypted. When the second endpoint 12 determines in step C.2 that the network packet N shall be encrypted prior to transmission via the network 2, the second endpoint 12 engages in step C.3 with the first secure network access device 14 via the communication network 2 to perform authentication and IKE data generation. In step C.4 the second endpoint 12 processes the network packet N with encryption and/or authentication techniques, and in accordance with the algorithms and data generated in step C.3, to generate a processed network packet P. The second endpoint 12 then transmits the processed network packet P via the communications network 2. After receipt of the processed network packet P, the first secure network access device 14 then authenticates and decrypts the processed network packet P in accordance with the flowchart of FIG. 6, wherein the first secure network access device 14 derives the network packet N from the processed network packet P, and provides the regenerated network packet N to the first endpoint 10.

In certain still additional alternate preferred embodiments of the Method of the Present Invention, the controller network computer 42, and optionally in combination with at least one secure network access device 6, 14 or 16 and at least two endpoints 8, 10 and 12, determines whether a particular network packet N shall be encrypted by applying stateful traffic rules. The stateful traffic rules may evaluate one or more of the qualities or aspects of the network packet N, to include the source IP address, the destination IP address and/or communications protocol of the network packet N. If the communications protocol of the network packet conforms to a TCP or a UDP standard, the source port and the destination port may also be partially or wholly determinative of the determination of whether the network packet may be encrypted. If the communications protocol of the network packet conforms to a ICMP standard, the source and destination types and codes may also be partially or wholly determinative of the determination of whether the network packet may be encrypted.

The rules may include other qualifications, such as group memberships required by clients or user attempting to access an endpoint 8, 10 or 12 or a secure network access device 6, 14 or 16. In certain alternate preferred embodiments of the second method, the controller secure network access device 42 maintains a trusted domain, wherein the trusted domain is limited to specified endpoints 8, 10 & 12 and secure network access device 6, 14 & 16 that are authorized to mutually authenticate as IKE negotiators with other members 6, 8, 10, 12, 14 & 16 of the trusted domain.

When a secure network access device 6, 14 & 16 is acting as a proxy for an endpoint 8, 10 or 12, incoming IKE messages addressed to the instant endpoint 8, 10 Or 12 and received by the secure network access device 6, 14 & 16 are examined to determine whether the destination IP address and the source destination IP address both indicate endpoints 8, 10 & 12 are listed as members of the trusted domain by the controller network computer 44. Where both the destination IP address and the source destination IP address are both members of the trusted domain, the secure network access device 6, 14 or 16 acts as a proxy for the endpoint 8, 10 or 12 coupled with the secure network access device 6, 14 or 16. When acting as a proxy, the secure network access device 6, 14 or 16 executes the first method as described herein.

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible embodiments of the Present Invention. The examples given should only be interpreted as illustrations of some of the preferred embodiments of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the Present Invention as disclosed and claimed should, therefore, be determined with reference to the knowledge of one skilled in the art and in light of the disclosures presented above.

We claim:

1. In a computer network comprising a first endpoint, a first secure network access device, a second secure network access device, and a second endpoint, a method for enabling electronic communications over a LAN, the method comprising:
the first endpoint using a first network interface to the first secure network access device to send a network packet addressed to the second endpoint;
the first secure network access device transparently processing the network packet on behalf of the first endpoint, such that the network packet retains the source and destination addresses as sent by the first endpoint, and forwarding the network packet into the LAN;
the LAN switching or routing the network packet over the same path as the network packet would have used had the network packet not been processed by the first network computer, delivering the network packet addressed to the second endpoint through the second network computer;
the second secure network access device transparently processing the network packet on behalf of the second endpoint; and
the second endpoint receiving the network packet as sent to the second endpoint by the first endpoint using a network interface of the second secure network access device.

2. The method of claim 1, wherein the network packet is authenticated by the first secure network access device and the second secure network access device.

3. The method of claim 1, wherein the network packet is encrypted by the first secure network access device.

4. The method of claim 3, wherein the first secure network access device comprises encryption acceleration hardware used to encrypt the encrypted message.

5. The method of claim 3, wherein the network packet is decrypted when processed by the second secure network access device.

6. The method of claim 3, wherein the second secure network access device comprises encryption acceleration hardware used to decrypt the encrypted message.

7. The method of claim 3, wherein the encrypted message appears in transit within the computer network to have been encrypted by the first endpoint.

8. The method of claim 1, whereby:
the second endpoint generates a second network packet and transmits the network packet to the second secure network access device;
the second secure network access device transparently encrypts and authenticates the network packet addressed to the first endpoint on behalf of the second endpoint;
the LAN switches or routes the network packet over the same path as the network packet would have used had the encryption not been applied; and
the first secure network access device receives the encrypted network packet from the LAN, transparently decrypts and authenticates the network packet on behalf of the first endpoint, and the first secure network access device forwards the network packet to the first endpoint.

9. The method of claim 8, wherein the second network packet appears in transit within the computer network to have been encrypted by the first endpoint.

10. The method of claim 8, wherein the second secure network access device comprises encryption acceleration hardware used to encrypt the second network packet.

11. The method of claim 8, wherein the first secure network access device comprises encryption acceleration hardware used to decrypt the second network packet.

12. The method of claim 1, wherein the computer network further comprises a first plurality of endpoints, and the endpoints are communicatively coupled with the first secure network access device, wherein the first secure network access device is configured to encrypt and authenticate messages sent from the first plurality of endpoints and to decrypt and authenticate messages sent to at least one endpoint of the first plurality of endpoints.

13. The method of claim 12, wherein the first plurality of endpoints are physically connected to the first secure network access device and the first secure network access device is the network access device for the first plurality of endpoints.

14. The method of claim 12, wherein the computer network further comprises an intermediate network access device, wherein the intermediate network access device is transposed between at least one endpoint of the first plurality of endpoints and the first secure network access device.

15. The method of claim 3, wherein the encrypting and decrypting of network packets complies with the IPsec encryption standard (RFC2401), and the encrypted messages comprise the MAC and IP addresses of the communicating endpoints

16. The method of claim 8, wherein the generation and the transmission of the second network packet by the second secure network access device is accomplished through a mode in conformance with either IPsec transport mode or IPsec tunnel mode.

17. The method of claim 16, wherein the encryption method includes IKE key management, and the first secure network access device provides a front-end proxy IKE key negotiation capability using the MAC and IP addresses of the first and second endpoint.

18. The method of claim 16, wherein the encryption method authenticates endpoints as members of a trusted domain, and that the first secure network access device authenticates itself as a member of the trusted domain, and the first secure network access device authenticates remote endpoints and alternate secure network access device as members of the trusted domain.

19. The method of claim 18, wherein at least one encryption policy for selectively encrypting communications packets is centrally administered, such that both the first secure network access device and the second secure network access device can be parties substantively contemporaneously configured.
